(19) United States
(12) Patent Application Publication
(10) Pub. No.: US 2022/0413971 A1
(43) Pub. Date: Dec. 29, 2022

(54) System and Method for Blockchain Based Backup and Recovery

(71) Applicant: ZEU TECHNOLOGIES, INC., Montreal (CA)

(72) Inventor: Yuming QIAN, Richmond Hill (CA)

(73) Assignee: ZEU TECHNOLOGIES, INC., Montreal, QC (CA)

(21) Appl. No.: 17/773,222

(22) PCT Filed: Nov. 2, 2020
(86) PCT No.: PCT/CA2020/051485

§ 371 Date: Apr. 29, 2022

Related U.S. Application Data
(60) Provisional application No. 62/928,703, filed on Oct. 31, 2019.

(51) Int. Cl. G06F 11/14; H04L 9/32; H04L 9/08

(52) U.S. Cl. CPC G06F 11/1469; G06F 11/1464; H04L 9/3247; H04L 9/0825

(57) ABSTRACT

A blockchain based system and method of data backup and recovery, for use with a conventional data store is disclosed. The system includes a blockchain that includes one or more nodes and a storage adaptation layer. The storage adaptation layer is in data communication with the blockchain and the data store, stores data from the data storage into the blockchain. The data store may be a relational database managing system or other type of data store. The system further includes a recovery adaptation layer configured to restore data in the blockchain to the data store. The recovery adaptation layer is also in data communication with the blockchain and the data store

### TECHNICAL FIELD

The present invention relates to data backup and recovery, and more particularly to real time data backup and recovery based on blockchain technology.

### BACKGROUND ART

A blockchain is a list of records, grouped into blocks, which are linked together using cryptography. Blockchain systems are used to maintain a reliable record of transactions by means of collective participation and consensus among participants. A blockchain can be understood as a distributed ledger technology, jointly maintained by multiple networked devices called nodes. A blockchain can thus be thought of as a distributed storage system.

Conventional storage systems utilizing database backup and recovery processes generally require substantial investment in redundant hardware and associated software. Moreover, the actual backup and recovery cycle, if executed, can typically be quite labor intensive. Accordingly, it is often expensive to set up a reliable system capable of real time backup and restoration of data, in an enterprise environment.

For real time data backup, conventional systems utilizing existing technology often requires the use of a powerful backup servers. However, the utilization rate of such powerful servers is often low, which translates to enormous waste of computing resources that have already been acquired.

If changes are made to the backup data in the backup server, then when the system is restored, the data in production database will be incorrect. There is thus a need for a reliable, secure, versatile, and inexpensive backup systems that meet the needs of various organizations.

One of the conventional ways to mitigate the problems associated with backup and restore operations is the use of incremental backup. During incremental backup, transaction logs are utilized to identify changes made since the last backup was taken, and only contents associated with changes that cannot be accounted for in the previous backup operation will be backed up in the next incremental backup procedure.

As a transaction log records only changes made to the database after a previous database backup or transaction log record backup, incremental backups only record database changes made during a limited period in between backup operations. Accordingly, a full database backup is required before undertaking a transaction record backup or an initial incremental backup.

There are several problems related to reliability, security and consistency of the aforementioned approaches.

In terms of reliability, there is the possibility that a central node of the backup system may fail. If there is a problem with the central node or machine associated with the backup transaction log, then data loss or damage may occur and the entire backup process may fail.

With regard to security and consistency, any unauthorized change to the transaction log could inevitably lead to recovered data that is not trustworthy.

Accordingly, there is a need for improved systems and methods to mitigate at least some of the aforementioned problems associated with backup and restore systems that utilize conventional hardware devices and technologies.

### SUMMARY OF INVENTION

In accordance with one aspect of the present invention, there is provided a blockchain-based backup and restore system and method. Embodiments of the present invention include blockchain-based backup-and-restore systems that are secure, reliable, and capable of real time operation.

In accordance with one aspect of the present invention, there is provided a data backup and recovery system, for use with a data store and a blockchain including a plurality of nodes, the system including: a server including one or more processors and memory; a storage adaptation layer executing on the server, the one or more processors in data communication with the blockchain and the data store; wherein the storage adaptation layer stores logs associated with a subset of changes in data stored within the data store, into the blockchain.

In accordance with another aspect of the present invention, the system may further include a recovery adaptation layer, in data communication with the data store and the blockchain, the recovery adaptation layer configured to retrieve stored data from the blockchain and store data corresponding to the retrieved stored data into the data store.

In accordance with another aspect of the present invention, there is provided a method of data backup and recovery. The method includes: tracking a subset of changes in the data stored at a data store, by a user, in a log; mapping the user to an account on the blockchain; encrypting the log using a public key of the account; and storing the encrypted data to cache; and storing the encrypted data to the blockchain.

The method may additional include: retrieving the data from the cache; triggering a blockchain contract in the blockchain for data consensus and global validation using the blockchain adapter; recording a new data change in a one of the plurality of said nodes; performing consensus voting in the blockchain; wherein upon said new data change conflicting with historical change record in the blockchain, the consensus voting fails; and otherwise, storing said new data change in a block in the blockchain.

In accordance with yet another aspect of the present invention, there is provided a real time data replication system based including: a blockchain; a target data store; a computing device. The computing device includes: a blockchain listening module adapted to listen to all blocks on the blockchain; a transaction filter filtering transactions on the blocks related to data replication; an event generator to convert content of the filtered transactions to data operations for execution on the target data store, the transaction content including pre-modification content, modified content, and operation type; and a data restore module for executing the data operations such that after execution the target data store is modified to correspond to the blockchain.

In accordance with yet another aspect of the present invention, there is provided a data backup and recovery system for a blockchain, including: a server including: a data adaptation layer; and a data storage system; wherein the data adaptation layer is connected to the blockchain, the data storage system comprises a distributed data store having one or more storage devices, and the data adaptation layer is adapted to facilitate communication between the data storage system and the blockchain. The data adaptation layer includes: a data change monitoring module that monitors data change records in the data storage system; a data conversion module adapted to format the monitored change records into a standard data change record; a blockchain contract to record the data to the blockchain.

### BRIEF DESCRIPTION OF DRAWINGS

In the figures, which illustrate by way of example only, embodiments of the present invention,

FIG. 1 is a schematic block diagram of a system utilizing a blockchain based backup and restore operation, exemplary of an embodiment of the present invention;

FIG. 2 is a flow diagram of an exemplary procedure for backing up data using the system of FIG. 1;

FIG. 3 is a flowchart summarizing real time data synchronization procedures in an exemplary embodiment of the present invention; and

FIG. 4 is a flowchart of an exemplary procedure for restoring data using the system of FIG. 1.

### DESCRIPTION OF EMBODIMENTS

The present disclosure describes a blockchain-based backup and restore system and method. Embodiments of the present invention include blockchain-based backup-and-restore systems that operate in a manner that satisfy one or more of the requirements for security, reliability, credibility and/or real time operations.

A description of various embodiments of the present invention is provided below. In this disclosure, the use of the word “a” or “an” when used herein in conjunction with the term “comprising” may mean “one,” but it is also consistent with the meaning of “one or more”, “at least one” and “one or more than one”. Any element expressed in the singular form also encompasses its plural form. Any element expressed in the plural form also encompasses its singular form. The term “plurality” as used herein means more than one, for example, two or more, three or more, four or more, and the like. Directional terms such as “top”, “bottom”, “upwards”, “downwards”, “vertically” and “laterally” are used for the purpose of providing relative reference only, and are not intended to suggest any limitations on how any article is to be positioned during use, or to be mounted in an assembly or relative to an environment.

The terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

A “blockchain” is a tamper-evident, shared digital ledger that records transactions in a public or private peer-to-peer network of computing devices. The ledger is maintained as a growing sequential chain of cryptographic hash-linked blocks.

A “node” in the context of a blockchain, is a device on the blockchain network. The device is typically be a computing device having a processor interconnected to a processor readable medium including memory, having processor readable instructions thereon.

The terms “first”, “second”, “third” and the like are used for descriptive purposes only and cannot be interpreted as indicating or implying relative importance.

In the description of the invention, it should also be noted that the terms “mounted”, “linked” and “connected” should be interpreted in a broad sense unless explicitly defined and limited otherwise. For example, it could be fixed connection, or assembled connection, or integrally connected; either hard-wired or soft-wired; it may be directly connected or indirectly connected through an intermediary. For technical professionals, the specific meanings of the above terms in the invention may be understood in context.

In the drawings illustrating embodiments of the present invention, the same or similar reference labels correspond to the same or similar parts. In the description of the invention, it should be noted that the meaning of “a plurality of” means two or more unless otherwise specified; The directions or positions of the terms “up”, “down”, “left”, “right”, “inside”, “outside”, “front end”, “back end”, “head”, “tail”, the orientation or positional relationship shown in the drawings is merely for the convenience of describing the invention and simplifying the description rather than indicating or implying that the indicated device or element must have a particular orientation and be constructed and operated in a particular orientation, and therefore cannot be used as a limitation of the invention.

### I. System Overview

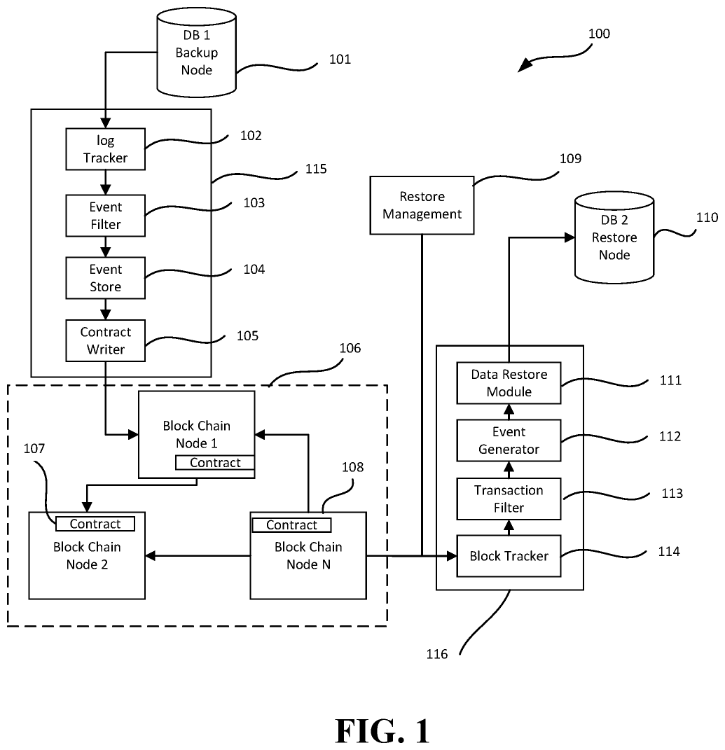

FIG. 1 schematically depicts a block diagram of a system utilizing a blockchain based backup and restore operation, exemplary of an embodiment of the present invention. The system includes a data source 101, a log tracker module 102, an event filter 103, an event store 104, a smart contract writer 105, a blockchain 106 a smart contract 107, a node 108, a restore management module 109, a target data store 110, data restore module 111, event generator 112, transaction filter 113 and block transfer 114.

A storage adaptation layer 115 may be defined to include the log tracker module 102, the event filter 103, the event store 104, and the contract writer 105.

A recovery adaptation layer 116 may comprise the data restore module 111, the event generator 112, the transaction filter 113 and the block transfer 114.

Data source 101 generates a change log, whenever data in the data source 101 changes. Data source 101 may be a relational database management system (RDBMS) such as Oracle™ database, MySQL™, Microsoft SQL Server™, and IBM DB2™ database. As may be appreciated, MySQL™ database generates bin-log whereas an Oracle™ database generates the redo-log.

Log tracker module 102 stores data changes based on logs. For different data sources, different data tracker plugins are used to capture data. For example, in a database system, one data tracker may emulate the replication client and connect to the main database and the main database may send the transaction log to the log tracker when a transaction is successful. After capturing the logs in the data source 101, the data tracker module 102 generates an internal structure or format to store the data changes.

Event filter 103 filters data based on configuration settings. Not all data needs to be backed up to the blockchain. Event filter 103 thus selects data matching a predefined condition or selection criteria for backup or restore and related processing.

Event store 104 temporarily stores an event. Event store 104 matches the speed between the blockchain and the data source. If the speed of the data change is faster than the blockchain write speed, the data is temporarily stored in a cache or message queue and waits for further processing. The cache or message queue, thus helps match the data rate of the change in the data source, to the data rate of writing to the blockchain. In this case, even when the system is disrupted, the captured data change is not lost and can continue processing when the system is restored.

Smart contract writer 105 encrypts the change event and triggers the contract in the blockchain. It is also a plugin for matching different blockchains.

Blockchain 106 is deployed in multiple sites and generates a network for consensus. In this exemplary embodiment, only transactions are stored and thus almost all blockchains may be supported.

Smart contract 107 is a smart contract running on the blockchain 106. Smart contract 107 takes changed data as input, verifies the account that submitted the change data, and checks the data matches with specific rules and formats. After most of the nodes agree on the consensus, the data is stored in a block as a transaction.

Node 108 is another node on blockchain 106 where the block containing the transaction is synchronized and can be extracted.

Restore management module 109 manages the data restoration process. The restore management module 109 controls restoration to a precise snapshot of data or a real time restoration to synchronize with the source data.

Target data store 110 is a data store that may or may not be the same type as the type used in data source 101. For example, data source 101 may be an Oracle™ database, while data store 110 may be MongoDB™. If choosing the same data type of data store, the modules on a given node Node-N may also be applied in Node-1 to restore data to data source 101 if the original data source 101 crashes.

Data restore module 111 in this embodiment, includes a plugin to match the target database. In the depicted embodiment, data restore module 111 converts a general JavaScript Object Notation (JSON) data to specific database operations. For example, for a relational database, data restore module 111 converts the operation to an SQL command, whereas for a NoSQL database, data restore module 111 uses another execution format.

Event generator 112 is used to generator event data. After filtering out the transactions, as data is encrypted, it is necessary to decrypt the event to get the changed data, and convert the changed data to JSON format.

Transaction filter 113 filters out transaction data required for backup and restore operations. A block may contain many kinds of transactions and an appropriate subset is filtered for data backup/restore transactions. After extracting the transactions from the block, it is also necessary to filter out events that are based on the restore side interests. For example, some target nodes are only interested in changes to a particular table, while other nodes may have different interests.

Block tracker 114 captures the target block in the blockchain 106. For real time synchronization, the tracker 114 starts from the current synchronized block and ends with the latest block in the chain.

### II. Backup Procedure

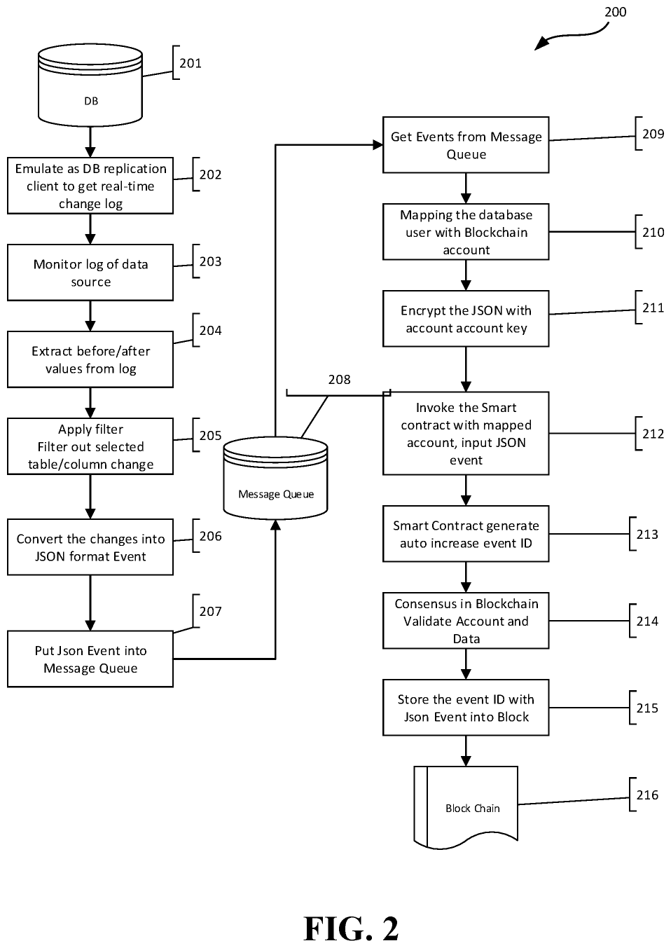

FIG. 2 depicts a flow diagram of an exemplary procedure 200 for backing up data using a system exemplary of an embodiment of the present invention, such as the system illustrated in FIG. 1. Each step of procedure 200 described below may be carried out by the system 100 which includes one or more processors on one or more server computing devices, connected to memory storing processor executable instructions that when executed cause the processor(s) to perform one or more of the steps recited below.

At step 201, a transaction takes place in a database where a piece of data is changed. One of the processors associated with running the database records the changed data and generates log in the form of a bin-log or redo-log to record the change.

At step 202 a backup server emulates the database replication client and connects to the database. The database copies the change log to the backup server.

At step 203 a monitor oversees the changes on the log.

At step 204, the log, if it is in raw mode, typically contains the “before” data, the “after” data, and the change type (“insert,” “delete,” or “update”).

At step 205, as resources are limited, and not all the data may need to be backed up, a user configures which database changes or table changes or column changes or row changes should be backed up to the blockchain 106. After extracting the data from the log, the configured filter is applied to filter out unwanted data.

At step 206, as the raw data format may be different in different data sources, an adapter is used to convert the data format to the desired (e.g., JSON format). An exemplary JSON format may look like: “{operator:“oliver”, “source-db”: “db 1”, “table”: “salary”, “operation”:“insert”, “before”: [{“id”:1, “name”:“oliver”, “salary”:“1500.00”}, {“id”:2, “name”:“frank”,“salary”:“2000.00”}], “after”: [{id”:1, “name”:“oliver”, “salary”:“1510.00”},{“id”:2, “name”:“frank”, “salary”:“2010.00”}]}

As may be appreciated, this does not record the original SQL command, but rather only the changes in data.

At step 207 the JSON event is placed into a message queue. As the speed of the log generation may fluctuate with the speed to invoke the blockchain contract, the message queue serves as a cache to buffer the changed data.

At step 208, the message queue temporarily stores the JSON data, and in case of a system crash, unsaved data is not lost. When the system recovers from the crash, it will continue from the point of interruption.

At step 209 events are retrieved from the message queue. The contract writer retrieves the JSON data from the message queue. If there are multiple sets of data, smart contract writer retrieves them and combines them into one JSON record.

At step 210 an account is needed to operate the blockchain. With the log, we can extract the database user to operate the data and map that user to a blockchain account in a configuration file.

At step 211 data is encrypted to prevent a third party from reading sensitive information in the database. The JSON data is encrypted using the account's public key.

At step 212 the smart contract is invoked in blockchain 106. The input is encrypted JSON data.

At step 213 the smart contract generates auto increase event identifier (ID). In a blockchain, time is needed to generate a block. During the period, multiple JSON records are stored. In one block, the sequence of transactions recorded is not guaranteed. The smart contract generates an auto increase sequence ID for each JSON record to identify the sequence within the same block.

At step 214 the smart contract is executed on most nodes in blockchain for consensus. The smart contract validates the account and the correctness of the JSON data. If the majority of nodes vote with the same result, the smart contract is executed successfully.

At step 215, after the smart contract is successfully invoked, the JSON data is recorded as smart contract input in the block.

At step 216, the generated block is again voted on for consensus in the blockchain before taking effect.

### III. Real time Data Synchronization Procedure

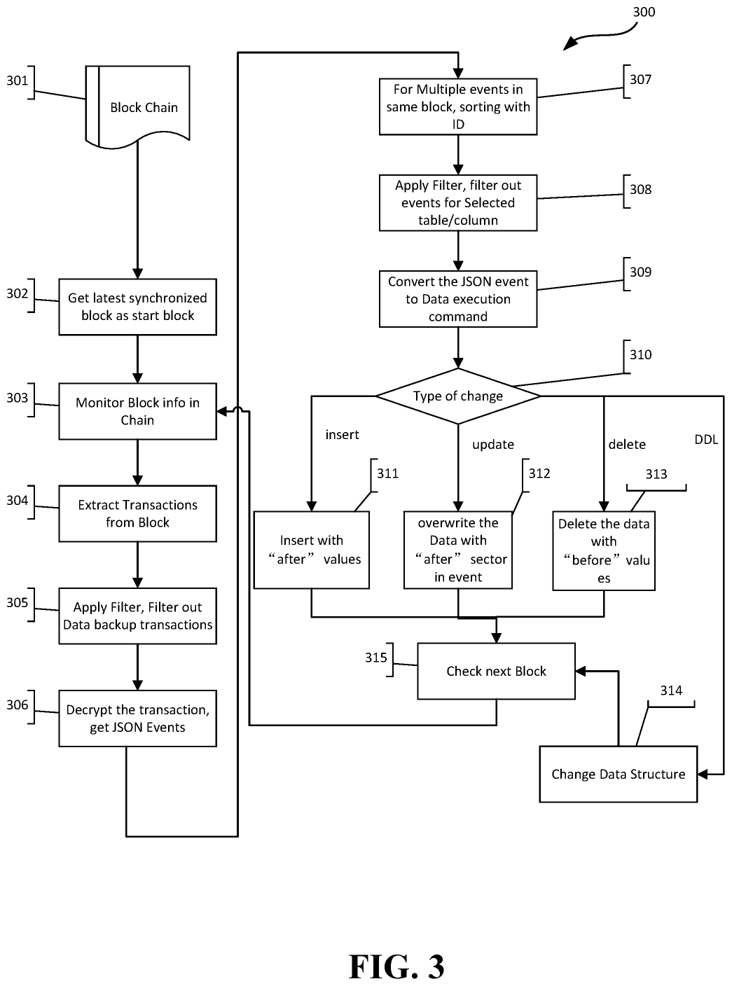

FIG. 3 depicts a flowchart summarizing real time data synchronization process in an exemplary embodiment of the present invention. In depicted embodiment, changed data is restored to another node in real time using a process 300 whose steps are enumerated below. Each step of procedure 300 described below may be carried out by the system 100 which includes one or more processors on one or more server computing devices, connected to memory storing processor executable instructions that when executed cause the processor(s) to perform one or more of the steps recited below.

At step 301 blockchain 106 generates a new block which contains encrypted JSON data.

At step 302 the current block height is obtained or designated as the target block, and the synchronized block is obtained or designated as the start block.

At step 303 the process monitors the block in the chain and retrieves the block information from the start block to the target block.

At step 304 the process extracts all transactions, in each block.

At step 305 a filter is applied. As there also may be other services running on the blockchain, this step filter out transactions generated by the backup/restore contract.

At step 306 the process decrypts the transaction and retrieve the clear text JSON event record with the account's private key. As the blockchain 106 is viewable by all nodes, this prevents unauthorized users from retrieving sensitive data in data storage. Only authorized accounts can access the data.

At step 307, the process sorts JSON events based on the unique ID generated by the smart contract. If multiple JSON events exist in the same block, the sequence in the block storage may not be the same as the sequence of events.

At step 308, another filter is applied. As the restored target side may not be interested in all changes in the data source, the process filters out only the data in which the target side is interested.

At step 309 the process uses a plugin to convert the JSON data to a data execution command. For different target data storage, it may use a different command to apply the changes.

At step 310, the process checks the type of JSON data, for a different database operation.

At step 311, an “insert” operation causes the use of the “after” data section to insert it into the target store.

At step 312 an “update” operation, causes the use of the “after” section of data in JSON to update the values in the store.

At step 313 a “delete” operation causes use the “before” section of data in JSON to find the matching record in the target store and remove it.

At step 314 the target data structure is changed according to the definition in the JSON record, for DDL (Data Definition Language) operations.

At step 315, after the current block is finished processing, the process goes to the next block in the chain until the latest block is reached. The process then goes to step 303 to start processing the new block.

### IV. Restoration Procedure

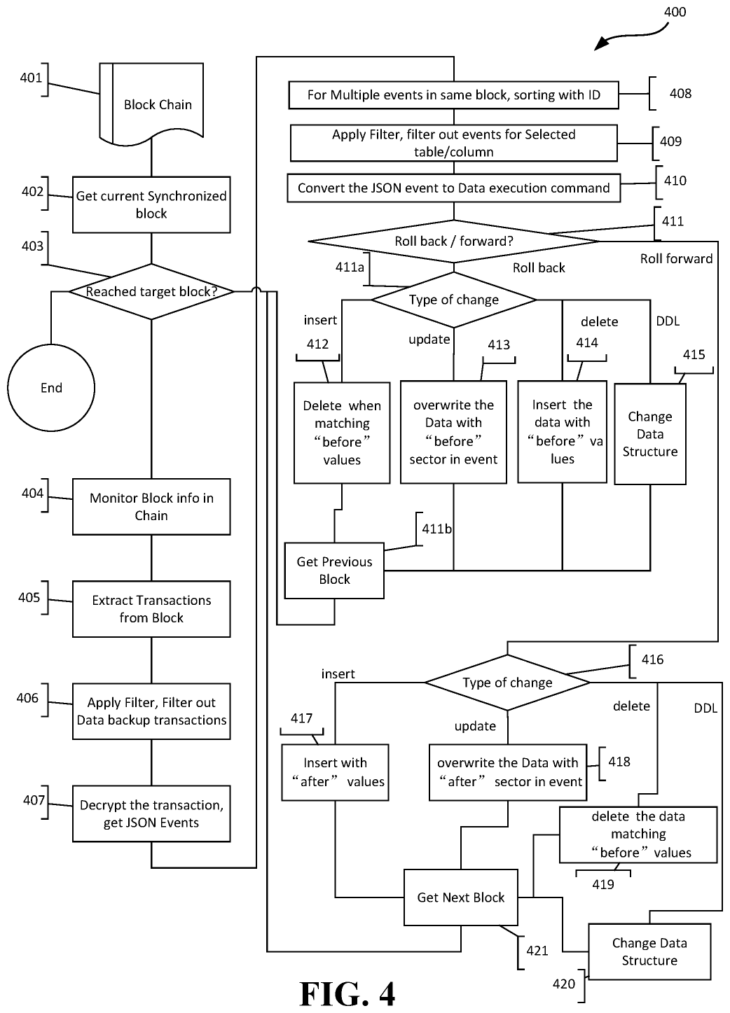

FIG. 4 is a flowchart of an exemplary procedure for restoring data using the backup and restore system of FIG. 1. Each step of procedure 400 described below may be carried out by the system 100 which includes one or more processors on one or more server computing devices, connected to memory storing processor executable instructions that when executed cause the processor(s) to perform one or more of the steps recited below.

In one scenario, the target data store is already synchronized to block 10,000. The process restores the target store status to block 8,000. The process extracts all the operations in the blockchain from block 10,000 to block 8,000 and revert the data change in reverse sequence, which is called a roll-back.

In another scenario, the target store is in block 8,000, and it is necessary to move the status to block 10,000 status. The process extracts operations in the blockchain from block 8,000 to block 10,000 and applies the changes in sequence, which is called a roll-forward.

The operation applied to a target data store is different in these two scenarios.

For a rollback operation, if the operation is “insert,” first a “delete” is applied for data matching the “after” values; for the “delete” operation, an “insert” is applied with “before” values.

For a roll-forward operation, the operation is kept the same as defined in JSON.

An exemplary process 400 is depicted with the aid of the flowchart in FIG. 4 is described below.

At step 401 the blockchain contains the change log in sequence.

At step 402 the process gets the current synchronized block height on the local data store.

At step 403 the process check the current height with target block height. If it is the same, it means it already reached the target status and could exit. If not, the process continues.

At step 404 the process monitor the block in the chain and retrieve the block information.

At step 405 the process extracts the transactions in the block.

At step 406 the process filters out the transactions generated by the backup/restore smart contract.

At step 407 the process decrypts the transactions in the block with the account's private key.

At step 408, if multiple events occur in the same block, the process retrieves the unique ID generated by the smart contract and sort using this ID. If a roll-back is needed, the process uses the reverse sort but otherwise uses the forward sort.

At step 409, as the target store may contain more than the request is interested in, the process applies the filter again to retrieve only the data in which the target store is interested.

At step 410, the process converts the JSON record to a data execution command based on the different data store type. For example, relational databases are converted to SQL commands, and MongoDB/Redis is converted to Mongo or Redis command.

At step 411, if the target block is greater than the current block, the process rolls forward but otherwise rolls back. The process checks the type of data change operation in JSON.

In roll-back mode, the type of change is determined at step 411a.

At step 412, in roll-back mode, if the operation is “insert,” the process applies “delete” action to the target store with data matching the “after” section.

At step 413, in roll-back mode, to update, the process changes the data back with the “before” section of data.

At step 414, in roll-back mode, if the operation is “delete,” the process applies the “insert” action with “before” values in JSON.

At step 415, if the data structure has changed, the process changes the data structure back.

After step 412, 413, 414, or 415, the previous block is retrieved at step 411b, and the method returns to step 403.

At step 416, in roll-forward mode, the process checks the data change operations.

At step 417, in roll-forward mode, the process applies “insert” with the “after” values in JSON.

At step 418, in roll-forward mode, the process applies “update” with the “after” values in JSON.

At step 419, in roll-forward mode, apply “delete” with the data matching the “before” values.

At step 420, for DDL, the process changes the structure defined in JSON.

At step 421, the process gets the next block in the chain.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. A data backup and recovery system, for use with a data store and a blockchain comprising a plurality of nodes, the system comprising:
a) a server comprising one or more processors in data communication with the blockchain and the data store; and
b) memory storing processor executable instructions, that when executed, cause the one or more processors to execute a storage adaptation layer on the server, the storage adaptation layer, comprising:
i) a log tracker module storing data changes based on a change log of data stored in the data store, the change log generated by the data store;
ii) an event filter for filtering a subset of the data changes to generate filtered events to be stored;
iii) an event store comprising a queue, for storing the filtered events; and
iv) a smart contract writer for writing data associated with the filtered events to the blockchain,
wherein the smart contract writer invokes a smart contract on the blockchain to write new data based on a filtered event retrieved from the queue, into the blockchain.

2. The system of claim 1, further comprising a recovery adaptation layer, in data communication with the data store and the blockchain, the recovery adaptation layer configured to retrieve stored data from the blockchain and store data corresponding to the retrieved stored data into the data store.

3. The system of claim 2, wherein the recovery adaptation layer comprises one or more of:
a) a data restore module for restoring data into the data store;
b) an event generator;
c) a transaction filter; and
d) a block transfer module.

4. The system of claim 1, further comprising the data store.

5. The system of claim 1, wherein the data store is distributed among one or more devices.

6. The system of claim 1, wherein the data store is a relational database management system (RDBMS).

7. The system of claim 1, wherein the data store is a MySQL™ database and the log comprises a bin-log.

8. The system of claim 1, wherein the data store is an Oracle™ database and the log comprises a redo-log.

9. The system of claim 1, wherein the data store is a NoSQL™ database.

10. The system of claim 1, wherein the blockchain is one of a plurality of different types of blockchains, and a corresponding blockchain adapter plug-in module is used by the storage adaptation layer to interface with the blockchain.

11. A method of data backup and recovery, the method comprising:
a) tracking a subset of changes in the data stored at a data store, by a user, in a change log;
b) mapping the user to an account on the blockchain;
c) encrypting data representative of the change log using a public key of the account, to form an encrypted data; and
d) storing the encrypted data to cache; and
e) storing the encrypted data from the cache to the blockchain.

12. The method of claim 11, wherein the blockchain comprises a plurality of nodes, the method further comprising:
a) retrieving the encrypted data from the cache;
b) triggering a blockchain contract in the blockchain for data consensus and global validation using the blockchain adapter;
c) recording a new data change in a one of the plurality of said nodes;
d) performing consensus voting in the blockchain; wherein
i) upon said new data change conflicting with historical change record in the blockchain, the consensus voting fails; and
ii) otherwise, storing said new data change in a block in the blockchain.

13. The method of claim 12, wherein said storing said new data change in the block is accomplished using a blockchain smart contract.

14. The method of claim 13, wherein upon multiple change events corresponding to multiple transactions being recorded in said block, a unique sequence ID is generated by the smart contract to identify a sequence of the transactions.

15. The method of claim 11, wherein the cache is a message queue.

16. The method of claim 11, further comprising: converting the log to a standard format prior to said encrypting the log.

17. The method of claim 11, further comprising: matching the data rate of the change to the data rate of writing to the blockchain.

18. The method of claim 17, wherein said matching prevents data loss in the event of a system crash.

19. A real time data replication system based comprising:
a) a blockchain;
b) a target data store;
c) a computing device comprising:
i) a blockchain listening module adapted to listen to all blocks on the blockchain;
ii) a transaction filter filtering transactions on the blocks related to data replication;
iii) an event generator to convert content of the filtered transactions to data operations for execution on the target data store, the transaction content including pre-modification content, modified content, and operation type; and
iv) a data restore module for executing the data operations such that after execution the target data store is modified to correspond to the blockchain.

20. The system of claim 19, further comprising a target data store adapter converting the data operations to one or more data execution commands for execution on the target data store.

21. The system of claim 19, wherein for multiple transactions in the same block, the multiple transactions are sorted with associated sequence IDs generated by a smart contract and executed in sequence.

22. The system of claim 19, wherein the computing device filters out unwanted events so that the unwanted events do not result in modification of the target data store.

23. The system of claim 19, wherein said filtering is based on feature values of the transactions within the blockchain.

24. The system of claim 19, wherein the blockchain is one of a plurality of different types of blockchains, and a corresponding blockchain adapter is used by the blockchain listening module.

25. The system of claim 19, wherein the computing device uses a private key to decode content of the filtered transactions.

26. The system of claim 19, wherein the computing device causes the target data store to roll-back or roll-forward to correspond to a desired block location of the blockchain.

27. A data backup and recovery system using a blockchain, comprising:
a data storage system;
a server comprising:
a storage adaptation layer comprising:
a data change monitoring module that monitors data change records in the data storage system, based on a change log of data stored in the data store, the change log generated by the data store;
an event filter for filtering a subset of the data change records to generate filtered events to be stored;
a data conversion module adapted to format the filtered events into a predefined format; and
a blockchain contract writer to extract change record data from the predefined format and record the extracted change record data the to the blockchain; and
a recovery adaption layer,
wherein the server is connected to the blockchain, the data storage system comprises a distributed data store having one or more storage devices, and the storage adaptation layer is adapted to facilitate communication between the data storage system and the blockchain, and
wherein the recovery adaptation layer comprises: a blockchain monitoring module that monitors all transaction information on the blockchain and filters specific transactions related to the backup and restore system.

28. The system of claim 27, wherein the storage adaptation layer further comprises: a data cache module adapted to cache the data change record in the predefined format.

29. The system of claim 28, wherein the blockchain write module activates a blockchain contract on the blockchain.

30. The system of claim 27, wherein the recovery module to restore data on to the data store based on a transaction record recorded on the blockchain.

31. The system of claim 30, wherein the recovery module is adapted to restore the distributed data store to a state corresponding to the blockchain.

32. The system of claim 30, further comprising one or more plug-in components adapting the storage adaptation layer to a respective one of one or more types of data sources.

33. The system of claim 30, wherein the change log of the data storage system comprises, for each change logged, a before data and an after data.

34. The system of claim 30, wherein the distributed data store comprise one or more of: relational databases, non-relational databases, file systems.

35. The system of claim 27, wherein the predefined format is a JavaScript Object Notation (JSON) format.
